(19) United States
(12) Patent Application Publication
(10) Pub. No.: US 2021/0153500 A1
(43) Pub. Date: May 27, 2021

(54) PLANT TREATMENT TECHNIQUES

(71) Applicant: Pratum Co-op, Salem, OR (US)

(72) Inventor: Troy M. KUENZI, Salem, OR (US)

(21) Appl. No.: 17/163,387

(22) Filed: Jan. 30, 2021

Related U.S. Application Data
(60) Provisional application No. 62/968,893, filed on Jan. 31, 2020.

(51) Int. Cl. A01N 3/00; B05D 1/02; G06K 9/00; G06K 9/46; G06T 7/90; G06T 7/10

(52) U.S. Cl. CPC A01N 3/00; B05D 1/02; G06K 9/00657; G06T 2207/20084; G06T 7/90; G06T 7/10; G06T 2207/30188; G06K 9/4652

(57) ABSTRACT

Techniques for treating an area with both crop plants and weeds involves applying a treatment to both the crop plants and the weeds to increase contrast between the crop plants and the weeds. For example, a non-lethal dose of herbicide may be applied to an area with both weeds and a crop to increase contrast in color, morphology, or both. The weeds may then be detected using artificial intelligence (AI) object detection, and an automated sprayer can then apply a second targeted treatment to the weeds based on the AI object detection. The first treatment to both the crops and the weeds that increased contrast between the crops and weeds enables higher accuracy object detection and therefore improves the performance of the automated sprayer.

### RELATED APPLICATIONS

This patent application is a nonprovisional application based on, and claims the benefit of priority of, U.S. Provisional Application No. 62/968,893, filed Jan. 31, 2020. The provisional application is hereby incorporated by reference.

### FIELD

The descriptions are generally related to agriculture, and more particularly, to improved techniques for the treatment of plants, such as treatments with herbicides, pesticides, fungicides, fertilizers, growth regulators, or other treatments.

### BACKGROUND

Agriculture has evolved significantly over the years as innovative technology has enabled higher crop yields and lower costs. Automation is one area that has led to improvements in agriculture. As computing technology becomes faster, smaller, and less expensive, more aspects of agriculture are automated with “intelligent” equipment. However, the accuracy of intelligent equipment is often lacking.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing at least one implementation of the invention that includes one or more particular features, structures, or characteristics. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 illustrates an example of a field that includes both crop plants and weeds.

FIG. 2A is a flow chart of an example of a plant treatment method.

FIG. 2B is a flow chart of an example of a method for identifying weeds based on the increase in contrast from the first treatment.

FIG. 2C is a flow chart of an example of a method of pre-processing an image.

FIG. 2D is a flow chart of an example of a method of computing weed positional data.

FIG. 2E is a flow chart of a method of applying a targeted treatment to the identified weeds.

FIG. 3 is a graph showing an example of the timing of treatments in the crop growth cycle.

FIG. 4 is a block diagram of an example of plant treatment equipment.

FIG. 5 is a block diagram of an example of a computing system.

FIG. 6 is an example of output from a plant detection/identification model.

FIG. 7 is another example of output from a plant detection/identification model.

Descriptions of certain details and implementations follow, including a description of the figures, which may depict some or all of the embodiments described below, as well as discussing other potential embodiments or implementations of the inventive concepts presented herein.

### DETAILED DESCRIPTION

Improved plant treatment techniques are described herein.

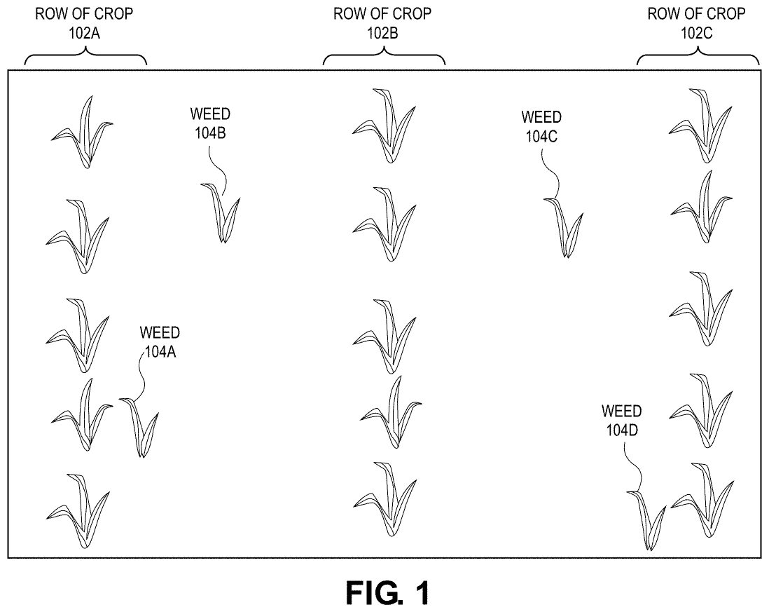

FIG. 1 illustrates an example of a field that includes both crop plants and weeds. A crop plant is a plant that is intentionally cultivated and grown, usually for eventual harvest. A weed is an undesired plant other than the crop plant that is growing in the same area as the crop plant. In the example illustrated in FIG. 1, the crop plants are located approximately in lines or rows 102A, 102B, and 102C. The weeds 104 can be found both in the rows of crop plants and in other areas, such as in between the rows of crop plants. For example, the weeds 104A and 104D are located relatively close to or within the crop rows, whereas the weeds 104B and 104C are located in between the crop rows.

Traditional methods of treating weeds growing amongst crops are time and labor-intensive. One example of a traditional method of treating weeds involves manually applying an herbicide spray to the weeds. Due to the time and labor-intensive nature of such treatments, some attempts have been made to automate plant treatment. For example, sprayers that use imagery to identify and spray only particular plants (such as only weeds) are under development. However, the accuracy of such intelligent or automated sprayers is often lacking, which can result in undesired plant treatments and the unnecessary waste of products.

For example, an automated sprayer that sprays only between crop rows or only over crop rows will result in both under and over treatment. As shown in FIG. 1, weeds can be located in close proximity to crop plant rows. Additionally, crop plants can sometimes be found outside of the expected crop rows. Therefore, a sprayer that relies on location alone may apply herbicide to crop plants that fall outside of the expected rows and fail to apply herbicide to weeds that are within the crop rows. Similarly, such a sprayer may result in the unintentional application of fertilizer to weeds that are located within crop rows, and failure to fertilize crop plants that fall outside of the expected crop rows.

In another example, an intelligent sprayer that uses imaging to distinguish between crop plants and weeds may fail to distinguish between crops and weeds that have a similar appearance. Consider an example in which both the crop and weed within a field are varieties or types of grass. For example, the crop plant may be a desirable grass such as tall fescue, perennial rye grass, or other desirable crop grass (such as cool season grasses generally). The weed may be an undesired “weed grass,” such as poa (e.g., poa annua or poa trivialis). If the appearance between the weed and crop are sufficiently similar, an intelligent sprayer using imaging will have a low accuracy rate in identifying which plants to spray.

In contrast, the techniques described herein involve applying a first treatment to both crop plants and weeds to increase contrast, and then applying a targeted treatment to the weeds. The first treatment enables improved identification of weeds (e.g., by an imaging-based intelligent sprayer) due to the increased contrast.

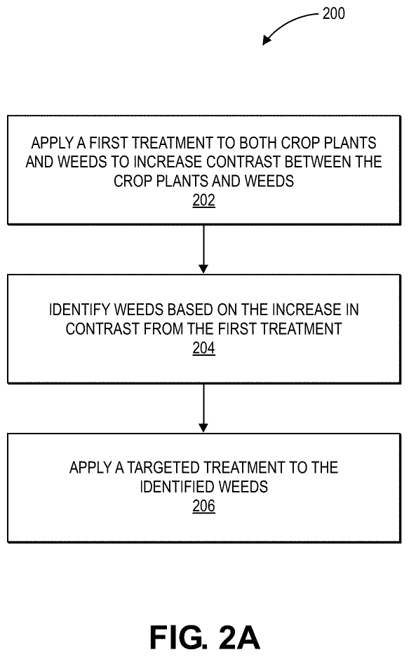

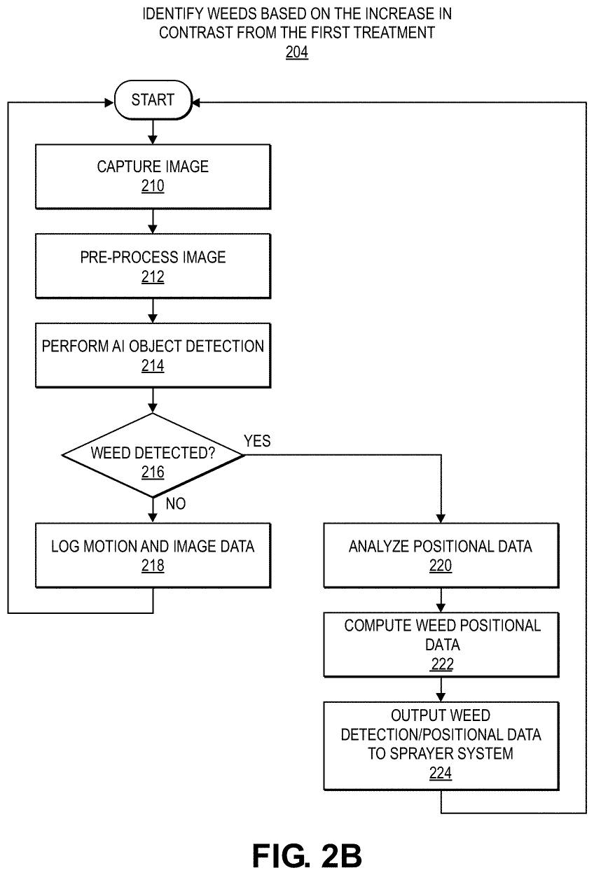

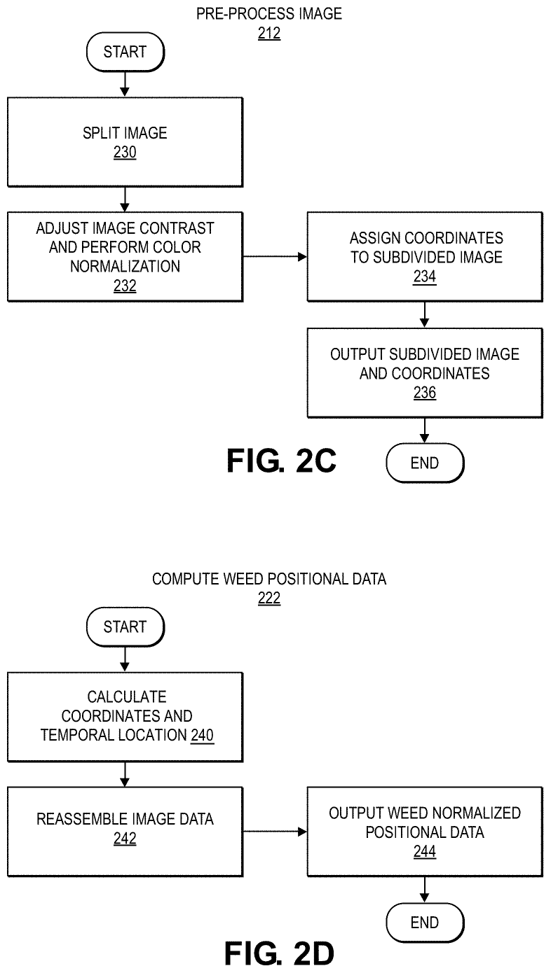

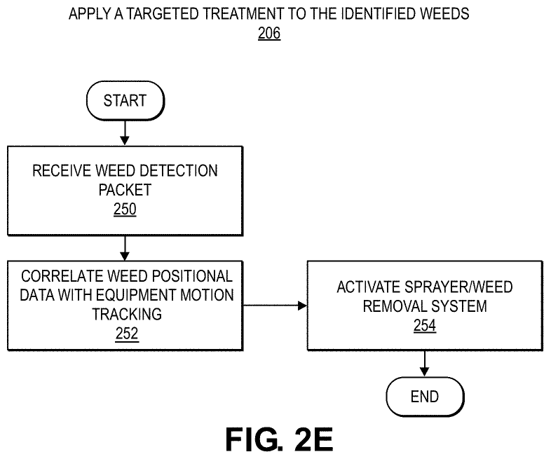

FIG. 2A is a flow chart of an example of a plant treatment method. The method 200 begins with applying a first treatment to both crop plants and weeds to increase contrast between the crop plants and the weeds, at 202. For example, referring to FIG. 1, the first treatment is a “broadband” treatment that is applied to both the crop plants 102A-102C and the weeds 104A-104D. The first treatment can be any treatment that increases contrast between the crop plants and weeds, at least temporarily. In one example, the treatment increases contrast in the color and/or morphology of the crop plants and weeds. Plant morphology refers to the physical, external attributes of a plant. Examples of plant morphology include the structure and appearance of stems, leaves, flowers, and seeds.

One example of a first broadband treatment is the application of a non-lethal dose of herbicide to both the crop plants and the weeds. In one such example, the herbicide is applied in an equal amount and concentration to both crop plants and weeds. The herbicide can be non-lethal due to, for example, the concentration of the herbicide (e.g., a diluted or low-dose herbicide that would be lethal at a higher concentration). The herbicide is typically applied in a liquid form with a sprayer. The herbicide can be applied manually or with automated spraying equipment. One example of an herbicide that may result in increased contrast at a non-lethal (but still within specification) dose is glufosinate. Examples of herbicides include non-selective or broad-spectrum herbicides such as glufosinate, glyphosate, paraquat, and clethodim. Other herbicides that result in increased contrast may also be used.

In order to create contrast, the herbicide needs to affect the weeds differently than the crop plants, at least temporarily. For example, a non-lethal dose of herbicide may cause the leaves of the weeds to turn yellow at a faster rate than the crop plants even though the same dose or concentration of herbicide is applied. In such an example, there is a window of time after application of the non-lethal dose of herbicide in which the weeds are yellow and the crop plants are still green, resulting in an increase in contrast. In another example, the non-lethal dose of herbicide may cause the leaves of the weeds to wither or change in shape more than (or at a faster rate than) the crop plants. Regardless of the effect, the non-lethal dose of herbicide is applied to not only the weeds, but also to the crop, to intentionally cause a change in color or morphology. Application of an herbicide is only one example of a treatment to increase contrast. Some examples of other treatments which may increase contrast include: a fertilizer, steam, flames (e.g., with a propane gun), hot air, or a cryogenic treatment. Regardless of which treatment is selected, the application of the first treatment results in an increase in contrast between the weeds and the crop plants for at least a period of time. The period of time can be, for example, days, weeks, or months, depending on the crop, weeds, and treatment.

After application of the first treatment, the method involves identifying the weeds based on the increase in contrast resulting from the first treatment, at 204. The weeds can be more easily identified due to the increased contrast from the first treatment. Therefore, sprayers that use imaging to detect plants can more easily identify and distinguish between the crop plants and weeds. For example, a sprayer can include hardware and software to capture images of plants and identify which of the plants are weeds. In one example, identifying weeds involves capturing images of at least a portion of an area (such as a field) that includes plants using one or more cameras. The captured images can then be provided to a plant detection/identification model. For example, the sprayer may include storage and memory to store and a processor to execute a model to detect and/or identify particular types of plants. The model can include or be based on artificial intelligence (AI) object detection algorithms, such as a neural network. The plant detection/identification model can then provide information indicating the locations of the identified weeds, the crop plants, or both the weeds and the crop plants in the captured in the image.

After identification of the weeds, the method involves applying a targeted treatment to the identified weeds, at 206. The targeted treatment can be automatically performed by treatment equipment (such as a sprayer or other equipment) based on the information indicating the locations of weeds from the plant detection/identification model. The targeted treatment can be performed by the same, or different equipment used to apply the first treatment. The targeted treatment can include any treatment to kill or eliminate weeds. Examples of targeted treatments include: a lethal dose of an herbicide (which can be the same herbicide used in the first treatment but at a higher concentration, or a different herbicide), cutting, extraction, steam, flames, hot air, or a cryogenic treatment. In another example, the targeted treatment involves application of a fertilizer or other treatment to the crop.

Consider an example in which the targeted treatment is a lethal dose of an herbicide. The lethal herbicide dose can be applied automatically with a sprayer that includes the imaging equipment and plant detection model discussed above. The sprayer can include multiple nozzles that are either activated or not activated to spray based on the information from the model in order to spray only the desired target plants. The nozzles may be stationary/fixed, or may be automatically adjusted (e.g., rotated (adjusting yaw, pitch, and/or roll), or moved (such as increasing or decreasing the distance between the nozzle and the target plant or the ground or otherwise moved)) to spray target plants based on the location information from the plant detection model. In one example, the sprayer equipment has multiple rows of nozzles that are individually and independently controllable to spray locations that the AI object detection model identified as containing weeds.

Although the method of FIG. 2A describes an example of treating weeds with the goal of eliminating the weeds, the same technique can be applied for other treatments, such as the application of fertilizers, pesticides, fungicides, growth regulators, or other treatments. For example, after the first treatment to increase contrast, the targeted treatment can be the application of fertilizer to crop plants identified with the plant detection model.

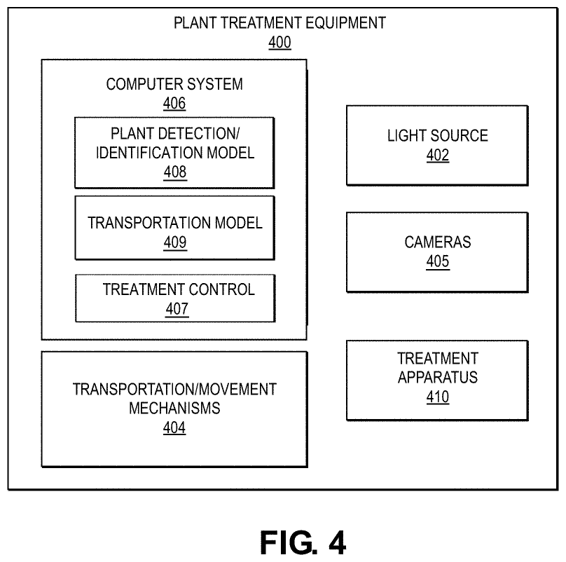

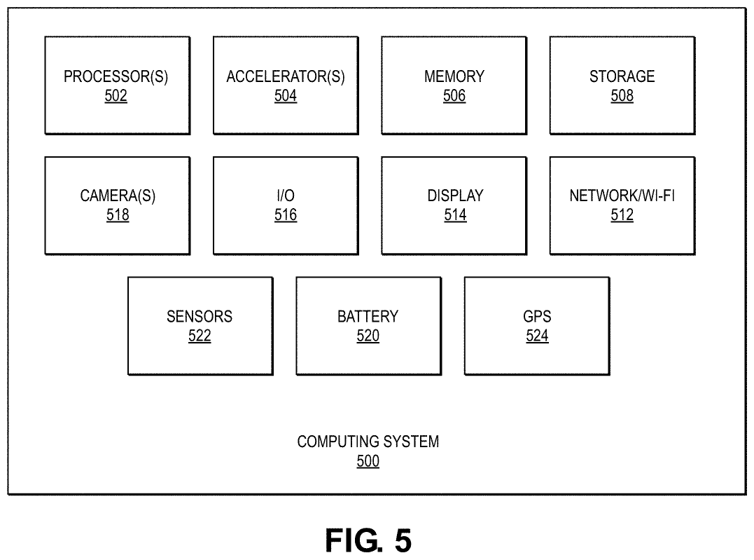

FIG. 2B is a flow chart of an example of a method for identifying weeds based on the increase in contrast from the first treatment (e.g., block 204 of FIG. 2A). FIGS. 2C-2D are flow charts of examples of sub-processes of FIG. 2B. The method of FIGS. 2B-2D may be performed with a software, firmware, and/or hardware. For example, the method of FIG. 2B may be performed by one or more software programs or processes running on a computing system, such as the system 406 of FIG. 4 or the system 5 of FIG. 5.

FIG. 2B starts with capturing an image or receiving a captured image, at 210. The image is captured by one or more cameras. For example, one or more cameras on a sprayer or other moving equipment captures images of the area to be treated. Pre-processing is then performed on the captured image, at 212. Examples of pre-processing an image include: splitting or tiling the image, cropping, resizing, applying filters, adjusting image contrast and color, color neutralization, coordinate assignment, or other image pre-processing. Splitting or tiling the image takes a single larger image and splits it up into smaller image tiles or sub-images.

The pre-processed image is sent to the AI network to perform object (e.g., weed) detection, at 214. In one example, each tile is sent to the AI network to perform object detection. The AI network may be, for example, a convolutional neural network that receives the pre-processed image tile as input and outputs a signal indicating whether a weed was detected in the image tile based on previous neural net training. Various algorithms may be used, for example, YOLO (You Only Look Once) and SSD (Single Shot Detection), or other AI algorithms for performing object detection.

If a weed was not detected by the AI network, 216 NO branch, then image and motion data may be logged, at 218. For example, image and motion data may indicate that the image frame was empty or that it contained objects other than the target plant. The method then loops back to capturing the next image, at 210.

If a weed is detected by the AI network, 216 YES branch, then the positional data is analyzed, at 220. Analyzing the position data may involve, for example, analyzing pre-determined coordinates of where the detected weed is in the image tile. Further positional data is computed, at 222, such as coordinates that indicate where the detected weed is in the larger image and temporal location based on the time the image was captured and motion tracking of the equipment that the cameras are mounted on. The further positional data may indicate a location of a weed to be treated.

In the example illustrated in FIG. 2B, the weed detection and positional data is output to a sprayer system, at 224. The sprayer system may include a sprayer control system that includes mechanical components such as sprayer nozzles and electronic components to control the mechanical components based on the weed positional data. For example, the sprayer system may include one or more rows of sprayer nozzles that are individually controllable to achieve the desired spray pattern based on the weed detection and positional data. Thus, where a weed is detected, the sprayer control system will trigger one or more specific sprayers at a specific time to treat the area with the detected weed. A sprayer is just one example of plant treatment equipment; in other examples, the weed detection and positional data is output to another type of weed elimination system.

FIG. 2C is a flow chart of an example of a method of pre-processing an image (e.g., block 212 of FIG. 2B).

The image pre-processing method of FIG. 2C starts with splitting a captured image, at 230. As mentioned above, splitting or tiling the image takes a single larger image and splits it up into smaller tiles or sub-images. Splitting the image may be useful when the captured image is high resolution or when parallel processing can be used to perform object detection on multiple tiles simultaneously. However, in other examples, object detection may be performed on the larger image without splitting the image prior to object detection.

Pre-processing may also involve adjusting the image contrast and performing color normalization, at 232. Where the image has been split into tiles, each tile may go through contrast and color correction to obtain tiles that have consistent color and contrast to reduce AI detection errors.

In the illustrated example, coordinates are assigned to each of the subdivided images or tiles, at 234. For example, the center of each tile could be assigned the coordinates (0,0), and any offset from the center of the image would have a non-zero scalar assigned relative to the center of the tile. In other examples, the coordinates (0,0) may be assigned to a corner of the tile. Alternatively, pixel-based coordinates may be assigned in which a pair of integers indicating a column and row identify a pixel of the tile. The pre-processed tiles of the subdivided image and tile coordinates can then be output for further processing, at 236.

FIG. 2D is a flow chart of an example of a method of computing weed positional data (e.g., block 222 of FIG. 2B).

The method of FIG. 2D starts with calculating coordinates and temporal location, at 240. Calculation of coordinates and temporal location may be based a time stamp for when the image was captured, time elapsed since the image was captured, movement of the treatment equipment with the camera and sprayers, and location of each tile within the larger image. The image data can then be reassembled from the individual tiles, at 242. The normalized positional weed detection data is then output, at 244.

FIG. 2E is a flow chart of a method of applying a targeted treatment to the identified weeds (block 206 of FIG. 2A). The method of FIG. 2E may be performed by software, firmware, hardware, and/or other mechanical equipment. For example, the method of FIG. 2E may be performed by the plant treatment equipment (e.g., by the treatment control 407, transportation model 409, transportation/movement mechanisms 404, and/or treatment apparatus 410 of FIG. 4).

The method of FIG. 2E begins with receiving a weed detection packet, at 250. For example, a sprayer system may receive weed detection and positional data determined in the method of FIG. 2B. The weed positional data is then correlated with the equipment motion tracking, at 252. Correlating the weed positional data with the equipment motion tracking may involve, for example, computing which sprayers (or other treatment apparatuses) to turn on at which times based on both the weed positional data and the motion of the equipment. The sprayer can then be activated according to spray from particular nozzles at particular times based on the correlated data, at 254. Thus, the high contrast between the weeds and the crops created by the first broadband treatment enabled high accuracy weed detection, which in turn enables automated targeted treatment of the weeds.

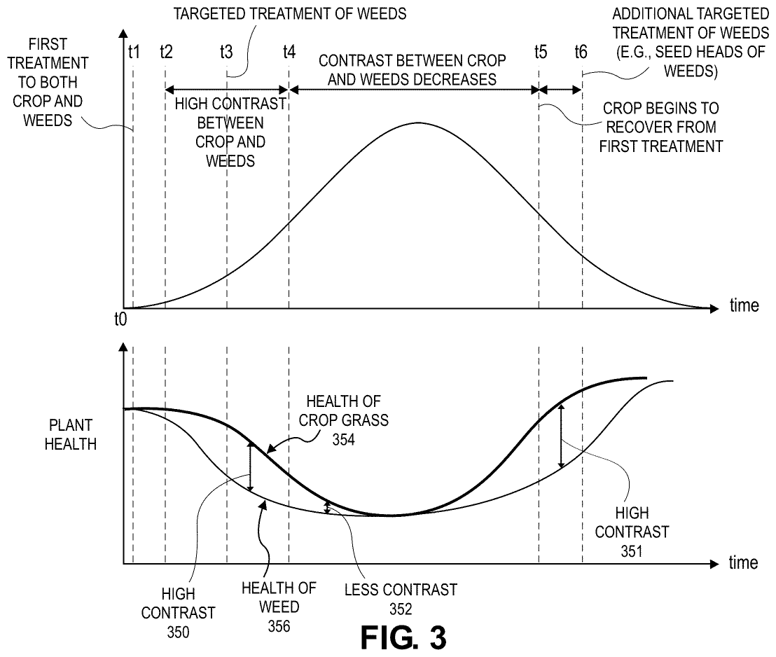

FIG. 3 includes two graphs showing an example of the timing of treatments in the crop growth cycle and its effect on the crop plants and weeds. The top graph represents the crop growth cycle and the bottom graph illustrates plant health over time.

Referring first to the top graph, at time t0, the crop is planted and has started to grow. At time t1, the first treatment is applied to both crop plants and weeds. For example, at time t1, an herbicide or other treatment is applied to both the crop and the weeds. At time t2, the contrast between the crop plants and weeds is starting to increase. For example, the weeds are starting to turn yellow, but the crop plants are still green. The contrast continues to be high until time t4. At time t3 (in the window of time between time t2 and t4 in which there is high contrast), the targeted treatment is performed. For example, a targeted treatment to eliminate the weeds can be performed with automated equipment based on detection of the weeds. The higher contrast enables a higher accuracy of weed detection. The contrast between crops and weeds then begins to decrease due to the crop plant also turning yellow.

At time t5, the crop plant begins to recover from the first treatment. The weeds that were treated with the second targeted treatment were either killed by the second treatment, or at least fail to completely recover. At time t6, any weeds which were not eliminated by the second treatment can be treated with a third treatment. In an example in which the weeds are a weed grass, remaining weeds may be identified by the seed heads of the weeds, which tend to be light in color and have a distinct morphology and are therefore easy to identify by an imaging-based plant detection model.

The bottom graph includes two curves representing plant health of a weed and a crop grass after a treatment with herbicide at time t1. The curve 354 represents the health of the crop grass. The curve 356 represents the health of the weed. As can be seen in the bottom graph of FIG. 3, the health of both the crop grass and weed decreases after the treatment at time t1. However, the health of the weed declines at a faster rate than the health of crop grass, resulting in a window of high contrast (see 350) between the crop grass and the weed. In the illustrated example, the health of the crop grass also declines, eventually resulting in a window of time where there is less contrast between the weed and crop (see 352). The targeted treatment at time t3 can be applied at a time of high contrast to enable higher accuracy of automated imaging-based treatment equipment.

The health of the crop and weed grasses begins to recover around time t5, however, the crop grass may recover more quickly than the weed grass. Therefore, in the illustrated example, there is a second window of high contrast (see 351) between the crop grass and the weed grass. Therefore, a targeted treatment may be performed between times t5 and t6 in addition to (or instead of) the targeted treatment at time t3. Although FIG. 3 shows an example of treatment and plant health of grasses, similar effects may be seen in other crop plants and weeds. For example, other crop plants and weeds may react differently to the first broadband treatment to create one or more periods of high contrast in color or morphology. Subsequent targeted treatments can then be performed with greater accuracy during the periods of high contrast created by the broadband treatment.

FIG. 4 is a block diagram of an example of plant treatment equipment. The plant treatment equipment 400 can be (or include) a sprayer and/or other plant treatment apparatuses to perform the treatments discussed herein. The plant treatment equipment includes a transportation/movement mechanism 404 to move the equipment through a field or other area including plants to be treated. The transportation/movement mechanism 404 can include, for example, wheels and one or more motors to enable rolling through an area to be treated. In another example, the equipment 400 can be a drone or other flying equipment to fly over an area to be treated. In one such example, the transportation movement mechanism includes propellers and/or wings in addition to a motor.

The equipment may also include a light source 402 to illuminate the area to be treated. The number, location, orientation, and wavelength of light sources may vary based on the plants being treated and the type of treatment used. In one example, multiple light sources (e.g., light bulbs) are mounted on the equipment which emit green (e.g., 550 nm), red (e.g., 650 nm), and/or infrared (e.g., 790-9950 nm) light. Typically, the light source 402 will be oriented so that the light source illuminates the area to be photographed and treated, for example, the ground (e.g., facing downward).

The equipment also includes one or more cameras 405. Like the light sources, the type, number, orientation, and location of the cameras may vary based on the type of plants being treated and the type of treatment used. Examples of cameras that may be used include: a silicon-based camera (e.g., an RGB matrix camera) in which the sensors are made from silicon, a monochrome camera, and a thermal camera. In one example in which a silicon-based camera is used, the camera can detect wavelengths of light in the range of 400 nm-1100 nm. The silicon-based camera may have the infrared filter removed so that the camera can detect infrared light. The silicon-based camera may include a Bayer filter.

In one example in which a monochrome camera is used, a Bayer filter may not be used (e.g., all pixels detect light evenly). In the example in which a thermal camera is used, the camera detects emitted light rather than reflected light so the equipment may not include the light source 402. The rate of capture of the cameras may vary depending on the area to be treated, the type and spacing of plants to be treated, and the type of treatment used. In one example, the rate of capture is 10-30 frames/second for a mobile vehicle moving 2-10 feet/second.

The equipment also includes one or more treatment apparatuses 410. The treatment apparatuses can include, for example, nozzles to apply a spray and containers to hold the liquid to be applied, propane guns or other sources of flames, blades or other means to physically cut or extract plants, or any other treatment apparatus. The treatment apparatuses 410 can include apparatuses to perform the first broadband treatment, the second targeted treatment, and/or additional treatments.

The equipment 400 also includes a computing system 406. The computing system 406 includes non-volatile storage to store the software/firmware and models. The computing system 406 may also include volatile memory in which to store software and models being executed. The computing system 406 also includes one or more processing devices (e.g., processors, graphic processing units (GPUs), general purpose GPUs (GPGPUs), or other processing devices such as special purpose accelerators (e.g., machine learning accelerators)). The processing device(s) execute the models for performing the plant detection and transportation. Referring again to FIG. 4, the computing system 406 of the equipment 400 may perform processing locally at the equipment 400 or may transmit data to a remote server for processing, or both. The computing system 406 on the equipment 400 may execute one or multiple models. The example in FIG. 4 depicts self-driving equipment that is controlled by a transportation model 409. The transportation model 409 may determine which areas have already been treated and which areas to treat and control the steering/movement of the transportation mechanisms 404. The transportation model 409 may also detect obstacles (e.g., people, animals, or other equipment or vehicles) and cause the equipment to stop or steer around the obstacles. Thus, the transportation model 409 may include various transportation and movement-related control logic to control the transportation mechanisms 404 of the equipment 400.

The computing system 406 also executes a plant detection/identification model 408. The plant detection model 408 uses image data captured by the cameras 405 as input to an AI object detection network/neural network for detecting plants. The model 408 may also distinguish between different types of plants, such as a crop plant and a weed. The model 408 can identify plants based on color information (e.g., the normalized difference vegetation index (NDVI) index for the plants in the image data), morphology, crop row/line identification, or a combination of color, morphology, and location relative to a crop row. The computing system 406 may also perform pre-processing of the image data prior to providing the data to the plant detection model. As mentioned above, pre-processing image data may involve splitting the image, cropping, resizing, applying filters, color and contrast adjustment, color normalization, coordinate assignment, or other image pre-processing. Based on the output of the plant detection model 408, the treatment apparatus 410 can apply a targeted treatment to only the desired plants.

The computing system 406 also includes or executes a treatment control system 407 to control operation of the treatment apparatus 410. In one example, the treatment control system 407 includes a sprayer control system to turn on or activate particular sprayer nozzles at particular times to treat target plants in response to the output from the plant detection/identification model 408.

FIG. 5 is a block diagram of an example of a computing system. The computing system 500 of FIG. 5 depicts examples of components which may be included on the equipment 400 or a computing system separate from the equipment 400. The computing system 500 can be, for example, user equipment, a computer, a personal computer (PC), a desktop computer, a laptop computer, a notebook computer, a netbook computer, a tablet, a smart phone, embedded electronics, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. One or more computing systems such as the system 500 is used to perform plant recognition (e.g., localization and/or classification) and/or control equipment for performing one or more treatments described herein.

The system 500 includes one or more processors or processing units 502. The processor(s) 502 may be host processors. The processor(s) 502 may include one or more central processing units (CPUs), each of which may include, e.g., a plurality of general-purpose processing cores. The processor(s) 502 may also or alternatively include one or more graphics processing units (GPUs) or other processing units. The processor(s) 502 may include memory management logic (e.g., a memory controller) and I/O control logic. The processor(s) 502 may include cache on a same package or near the processor.

The system 500 may also include one or more accelerators 504 or other computing devices. Accelerators can be used to perform specific operations that may be offloaded to the accelerator by a host processor. For example, the computing system 500 may include an Artificial Intelligence (AI) or machine learning accelerator optimized for performing operations for machine learning algorithms, a graphics accelerator (e.g., GPU), or other type of accelerator. An accelerator can include processing circuitry (analog, digital, or both) and may also include memory within the same package as the accelerator.

The system 500 also includes memory 506 (e.g., system memory). The memory 506 stores data and instructions being executed by the processor(s) 502. The memory 506 is typically used as temporary storage while data is being operated on or otherwise accessed and may be stored in mass storage 508 for subsequent retrieval. The memory can be in the same package (e.g., same SoC) or separate from the processor(s) 502. The system 500 can include static random-access memory (SRAM), dynamic random-access memory (DRAM), or both. In some examples, memory 506 may include volatile types of memory including, but not limited to, RAM, D-RAM, DDR SDRAM, SRAM, T-RAM or Z-RAM. One example of volatile memory includes DRAM, or some variant such as SDRAM. In one example, the memory 506 includes a byte or bit-addressable non-volatile memory such crosspoint memory.

The system 500 also includes non-volatile storage 508, which may be the mass storage component of the system. Non-volatile types of memory may include bit, byte or block addressable non-volatile memory such as NAND flash memory (e.g., multi-threshold level NAND), NOR flash memory, single or multi-level phase change memory (PCM), crosspoint memory, or other non-volatile memory. For these examples, storage 508 may be arranged or configured as a solid-state drive (SSD), a USB flash drive (e.g., “thumb drive”), or other non-volatile memory configuration.

The system 500 may include a network interface 512 to provide the system 500 the ability to communicate with remote devices (e.g., servers or other computing devices) over one or more networks. The network interface 512 can include an Ethernet adapter, wireless interconnection components, cellular network interconnection components, USB (universal serial bus), or other wired or wireless standards-based or proprietary interfaces. The network interface 512 can exchange data with a remote device, which can include sending data stored in memory or receiving data to be stored in memory 506. Thus, the network interface 512 can represent various connectivity interfaces to provide one or more of cellular connectivity, wireless connectivity, wired connectivity, etc. Cellular connectivity refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), 5G, or other cellular service standards. Wireless connectivity refers to wireless connectivity that is not cellular and can include personal area networks (such as Bluetooth), local area networks (such as WiFi), or wide area networks (such as WiMax), or other wireless communication, or a combination. Wireless communication refers to transfer of data through the use of modulated electromagnetic radiation through a non-solid medium. Wired communication occurs through a solid communication medium. In one example, data collected and or processed on treatment equipment can be transmitted via one or more networks to a remote computing system for storage or further processing.

Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Switch Specification. Other examples of communications interfaces include, for example, a local wired point-to-point link (e.g., USB) interface, a wireless local area network (e.g., WiFi) interface, a wireless point-to-point link (e.g., Bluetooth) interface, a Global Positioning System interface, and/or other interfaces.

In addition to the network, WiFi, and cellular interfaces, the system may include one or more other input/output (I/O) communication interfaces 516 that operate according to various communication protocols or standards to communicate over direct or network communication links or channels. Direct communications may occur via use of communication protocols or standards described in one or more industry standards. For example, I/O interfaces can be arranged as a Serial Advanced Technology Attachment (SATA) interface to couple elements of a computing system to a storage device. In another example, I/O interfaces can be arranged as a Serial Attached Small Computer System Interface (SCSI) (or simply SAS), Peripheral Component Interconnect Express (PCIe), or Non-Volatile Memory Express (NVMe) interface a storage device with other elements of a computing system (e.g., a controller, or other element of a computing system). NVM Express standards are available at www.nvmexpress.org. PCIe standards are available at pcisig.com.

The system 500 may include one or more displays 514 driven by a graphics interface. In one example, the display is 514 a high definition (HD) display or ultra high definition (UHD) display that provides an output to a user. In one example, the display 514 can include a touchscreen display. In one example, a graphics interface generates a display based on data stored in memory 506 or based on operations executed by processor 502 or both. For example, the display may show captured images, output from the AI object detection processes (e.g., bounding boxes identifying weeds and/or crop plants), areas to treat, areas that have been treated, etc.

The system 500 may include one or more cameras 518. The cameras can be the same as, or similar to, the cameras 405 of FIG. 4, discussed above. The cameras 518 are connected to the system 500 to enable accessing of and processing of the images captured by the cameras 518 real time. The system 500 may include a Global Positioning System (GPS) controller and receiver 524 to vice receive information from satellites and determine the system's geographical position (e.g., via location coordinates).

The system 500 may include one or more sensors 522. The sensors 522 represent embedded sensors or interfaces to external sensors, or a combination. The sensors 522 enable the system 500 to monitor or detect one or more conditions of an environment or a device in which the system 500 is implemented. The sensors 522 can include environmental sensors (such as temperature sensors, motion detectors, light detectors, cameras, chemical sensors (e.g., carbon monoxide, carbon dioxide, or other chemical sensors)), pressure sensors, accelerometers, gyroscopes, or other sensors, or a combination.

The system 500 includes a power source, such as a battery 520. In one example, the system includes an AC to DC (alternating current to direct current) adapter to plug into a wall outlet. Such AC power can be renewable energy (e.g., solar power, motion based power). In one example, the power source includes only DC power, which can be provided by a DC power source, such as an external AC to DC converter. In one example, the power source includes wireless charging hardware to charge via proximity to a charging field. In one example, the power source can include an internal battery or fuel cell source. Thus, the system 500 is an example of a computing system that may be used to perform one or more of the methods described herein.

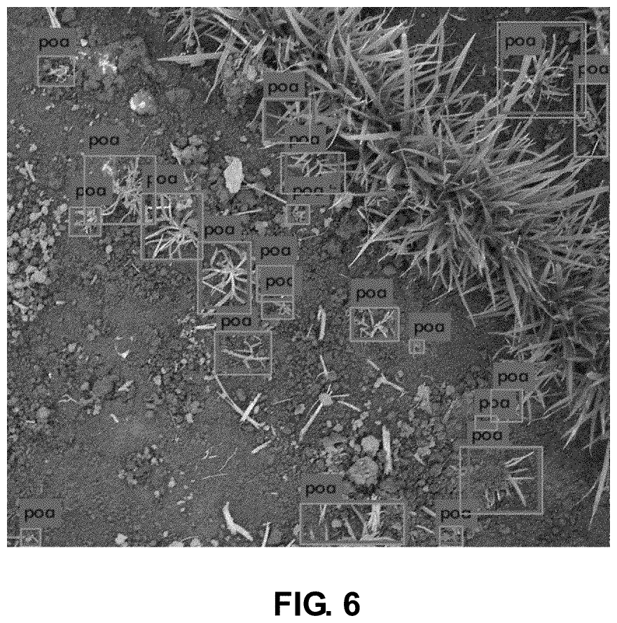

FIG. 6 is an example of output from AI object detection processes. The output in FIG. 6 identifies poa, a weed grass based on the color contrast achieved through the first broadband treatment. FIG. 6 shows bounding boxes around detected poa weed grass (boxes based on coordinates of the detected weeds). The color of the poa weed grass is significantly different than the crop grass due to the first treatment that caused discoloration of the poa weed grass prior to discoloration of the crop grass.

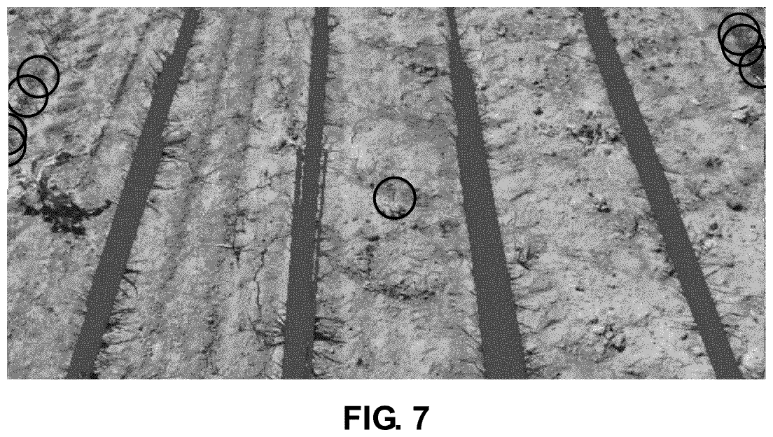

FIG. 7 is another example of output from AI object detection processes. The output in FIG. 7 identifies the weed grass based on location outside of a crop row. In FIG. 7, lines show the detected crop rows and circles show the detected plants outside of the crop rows. As can be seen in FIG. 7, the model identifies the crop rows, and any plants outside the crop row may be weeds. A model can use a combination of factors such as color, morphology, and location relative to crop rows to increase the likelihood of correctly predicting which plants are weeds and which plants are crops. Although FIGS. 6 and 7 show specific examples of detecting a weed grass (e.g., poa annua or poa trivialis), the techniques described herein may be performed for any plants for which different treatment is desired (e.g., crops and weeds). Furthermore, although some examples refer to eliminating weeds, other targeted treatments may be performed to target plants in periods of high contrast caused by a broadband treatment.

Thus, a technique in which a broadband non-lethal treatment is applied to crop plants and weeds increases the contrast between the plants. A second targeted treatment can then be performed, such as with intelligent treatment equipment that uses an imaging-based model to identify weeds and/or crops based on the increased contrast from the broadband treatment.

What is claimed is:

1. A method comprising:
applying an herbicide to an area including both crop plants and weeds;
identifying weeds based on an increase in contrast between the crop plants and the weeds from the herbicide application; and
applying a targeted treatment to the identified weeds.

2. The method of claim 1, wherein:
application of the herbicide is to increase the contrast between the crop plants and the weeds in one or more of: color and morphology.

3. The method of claim 1, wherein:
applying the herbicide comprises: applying a non-lethal dose of the herbicide.

4. The method of claim 1, wherein:
the targeted treatment comprises one or more of the following applied to the identified weeds: a lethal dose of the herbicide, a lethal dose of a different herbicide, cutting, extraction, steam, flames, hot air, and a cryogenic treatment.

5. The method of claim 1, wherein identifying the weeds comprises:
capturing an image of at least a portion of the area with one or more cameras; and
performing artificial intelligence (AI) object detection to identify the weeds in the captured image.

6. The method of claim 5, wherein performing AI object detection comprises:
performing AI object detection with a neural network.

7. The method of claim 5, wherein performing AI object detection comprises:
identifying which plants in the captured image are the weeds based on a normalized difference vegetation index (NDVI) index for the plants.

8. The method of claim 5, further comprising:
performing pre-processing on the captured image prior to performing AI object detection.

9. The method of claim 8, wherein performing pre-processing on the captured image comprises:
splitting the captured image into multiple image tiles;
adjusting contrast in each of the multiple image tiles; and
performing color normalization for each of the multiple image tiles.

10. The method of claim 9, wherein performing pre-processing on the captured image comprises:
assigning coordinates to each of the multiple image tiles.

11. The method of claim 5, wherein:
the targeted treatment is performed with an automated sprayer including:
a light source to illuminate plants in the portion of the area captured in the image;
the one or more cameras to capture the image;
one or more processors to perform AI object detection; and
multiple nozzles to spray the identified weeds based on the AI object detection.

12. The method of claim 11, wherein the one or more processors are to further:
determine which of the multiple nozzles to activate based on computed location of the weeds relative to locations of the multiple nozzles.

13. The method of claim 12, wherein the one or more processors are to further:
determine which of the multiple nozzles to activate based further on speed of the automated sprayer.

14. An article of manufacture comprising a computer readable storage medium having content stored thereon which when accessed causes the performance of operations to execute a method comprising:
applying an herbicide to an area including both crop plants and weeds;
identifying weeds based on an increase in contrast between the crop plants and the weeds from the herbicide application; and
applying a targeted treatment to the identified weeds.

15. The article of manufacture of claim 14, wherein:
application of the herbicide is to increase the contrast between the crop plants and the weeds in one or more of: color and morphology.

16. The article of manufacture of claim 14, wherein:
applying the herbicide comprises: applying a non-lethal dose of the herbicide.

17. The article of manufacture of claim 14, wherein:
the targeted treatment comprises one or more of the following applied to the identified weeds: a lethal dose of the herbicide, a lethal dose of a different herbicide, cutting, extraction, steam, flames, hot air, and a cryogenic treatment.

18. An automated sprayer including:
one or more sprayer nozzles to spray an area including both crop plants and weeds with an herbicide;
a light source to illuminate the area;
one or more cameras to capture an image of the area; and
one or more processors to:
perform artificial intelligence (AI) object detection to identify the weeds in the captured image based on an increase in contrast between the crop plants and the weeds from the herbicide application; and
based on locations of the identified weeds, activating one or more of the sprayer nozzles to apply a targeted treatment to the identified weeds.

19. The automated sprayer of claim 18, wherein:
application of the herbicide is to increase the contrast between the crop plants and the weeds in one or more of: color and morphology.

20. The automated sprayer of claim 18, wherein:
applying the herbicide comprises: applying a non-lethal dose of the herbicide.
